(19) United States
(12) Patent Application Publication
(10) Pub. No.: US 2015/0227658 A1
(43) Pub. Date: Aug. 13, 2015

(54) GENERATING A SIMPLIFIED CALCULATION MODEL AND PREDICTING LIFE CONSUMPTION OF A COMPONENT

(71) Applicants: Roger Persson, Trollhattan (SE); Mattias Henriksson, Goteborg (SE)

(72) Inventors: Roger Persson, Trollhattan (SE); Mattias Henriksson, Goteborg (SE)

(21) Appl. No.: 14/407,623

(22) PCT Filed: Jun. 19, 2012
(86) PCT No.: PCT/SE2012/000096

§ 371 Date: Apr. 29, 2015

(51) Int. Cl. G06F 17/50; G06F 17/10

(52) U.S. Cl. CPC G06F 17/5018; G06F 17/10

(57) ABSTRACT

A simplified calculation model for use in predicting life consumption of a component subjected to loads during operation may be generated. Accordingly, a first set of load input data resulting from a first set of load sessions during operation is received. At least one of stresses, strains and temperatures for a critical area of said component is calculated by a numerical calculation model. Life consumption of said component is predicted based on said at least one of the numerically calculated stresses, strains and temperatures. Said simplified calculation model is generated defining a relationship between load input data and predicted life consumption by: assigning a plurality of linear difference equations for said simplified calculation model, and calculating parameters of said plurality of linear difference equations based on said relationship between the first set of load input data and said numerically calculated predicted life consumption.

### CROSS-REFERENCE TO RELATED APPLICATIONS

This application is a National Phase of, and claims priority to, International Application No. PCT/SE2012/000096 filed on Jun. 19, 2012, which application is hereby incorporated by reference in its entirety.

### BACKGROUND

Today, there is significant interest in the prediction of the life consumption of individual components in a machine, e.g., machines with moving parts. By improving the accuracy of such methods, applied safety limits may be reduced, and unnecessary replacement of components may be avoided. When applied to an entire fleet (e.g. a military aircraft fleet) the cost savings may be significant as well as allowing for an increased operational lifetime. Furthermore, in the unusual event that conventional methods are too optimistic, refined methods may avoid failure of components, thus avoiding uncalculated stops in operation or even more importantly accidents.

Examples of interesting applications where improved life consumption predictions may be useful include aircrafts, gas/steam turbines, trucks, loaders, nuclear plants and wind turbines.

A conventional method for predicting the life consumption of a component in a machine is to measure one or a combination of the usage/run time, distance or count the number of cycles of a predefined load session or a conservative load session. A load session is the time when the machine is in operation, for example for an aircraft a load session may be defined as flying from point A to point B with a predefined rotor speed variation. Prediction of the estimated life consumption of the component may thereafter be calculated by using a numerical calculation method, such as e.g. the finite element method, FEM. The FEM-method calculates stresses and strains for the component exposed to various loads during the load session, such as e.g. thermal and mechanical loads. The FEM-method calculates stresses and strains by using a mesh pattern on e.g. a 2D-model or a 3D-model, wherein the mesh pattern comprises nodes and elements. By utilizing a denser mesh, i.e. smaller elements per area resulting in a larger number of nodes and elements, the accuracy of the results are improved.

Although the FEM-method provides for a substantially accurate method for determining the stresses and strains of a component exposed to a load session, the FEM-method is very time consuming in terms of required CPU (central processing unit)-time. In particular, the required CPU-time increases significantly for components having, e.g., a complicated geometry, contact surfaces to other components, or where there is a need of providing a denser mesh for achieving reliable results.

Hence, there is a need for an improved calculation method which is less time consuming while still providing reliable results.

### SUMMARY

Disclosed herein is a method for generating a simplified calculation model for use in predicting life consumption of a component which is less time consuming in relation to finite element models, FE-models, while still being able to provide reliable results. Also disclosed is a method for predicting life consumption of components.

Calculation of life consumption of components, and more specifically generating a simplified calculation model, may be based on load data from a load session and on actual stresses, strains, temperatures and life consumption calculated by means of a numerical calculation model. Further, life consumption for a component may be predicted using a simplified calculation model and especially the generated simplified calculation model. Moreover, a system and computer program product are disclosed for generating the simplified calculation model and for predicting life consumption of components.

The presently disclosed subject matter is based on the insight that calculation of, e.g., stresses, strains, temperatures and predicted life consumption for a component exposed to a set of loads can be accomplished by means of a simplified calculation model instead of using a complex and time consuming FE-model. By generating a simplified calculation model using already known results from a numerical method model exposed to a load session resulting from a set of load input data, the simplified calculation model can thereafter be used for other sets of load input data for calculating stresses, strains and temperatures exposed to the component. Hereby, a less time consuming calculation model is provided which is able to provide reliable results in terms of e.g. stresses, strains, temperatures and predicted life consumption for the component.

According to a first aspect of the present disclosure there is provided a method for generating a simplified calculation model for use in predicting life consumption of a component subjected to loads during operation, comprising the steps of: receiving a first set of load input data resulting from a first set of load sessions during operation; calculating at least one of stresses, strains and temperatures for a critical area of the component by means of a numerical calculation model; predicting life consumption of the component based on the at least one of the numerically calculated stresses, strains and temperatures; and generating the simplified calculation model defining a relationship between load input data and predicted life consumption by means of: assigning a plurality of linear difference equations for the simplified calculation model; and calculating parameters of the plurality of linear difference equations based on the relationship between the first set of load input data and the numerically calculated predicted life consumption.

The term “numerical calculation” should in the following and throughout the entire description be interpreted as a calculation method using explicit or implicit iterative calculations in order to achieve a desired result. The numerical method may use a mesh or a grid provided to, e.g., 2D- or 3D CAD models, which calculates, e.g., stresses, strains and temperatures for each node and/or element provided by the mesh/grid. The numerical calculation method may, for example, use the finite element method, FEM, to calculate stresses and/or strains, which will be described further below.

Moreover, the “critical area of a component” should be understood to mean a position of a component in e.g. an engine which is likely to be affected, or has been identified by other means to be relatively highly affected, by loads during operation. A position of the component may, for example, be regarded as a critical area if it is positioned in proximity to a high-temperature element of the engine or if it e.g. comprises a curved-shaped form having a relatively small radius in which stress concentrations are likely to occur. The list of the types of critical areas can hence be extensive and the specific area of interest must therefore be evaluated for the specific component of interest. Details of how to select critical areas of a component is disclosed in a co-pending application serial no. PCT/SE2012/000094, filed Jun. 19, 2012, entitled “RELIABLE PREDICTION OF LIFE CONSUMPTION OF A MACHINE COMPONENT”, herewith incorporated by reference herein in its entirety. The critical area of the component may hence be regarded as a limiting factor when evaluating predicted life consumption of the total engine component.

Furthermore, the simplified calculation model should in the following be interpreted as a calculation model which comprises a set of linear difference equations that is built up by use of known input and known output, i.e., input and output received from the above mentioned numerical calculation model. The simplified calculation model hence comprises a plurality of parameters which are calculated by means of linear difference equations such that a relation between the inputs, i.e. the loads, and the outputs, i.e. the stresses, strains, temperatures and/or the predicted life consumption corresponds to the corresponding inputs and outputs of the numerical calculation model. In more detail, the parameters are configured to linearly describe the relation between the inputs and the outputs of the simplified calculation model so that its predicted life consumption more or less resembles the predicted life consumption calculated by means of the numerically calculated component.

Still further, the set of load input data described may be provided by, for example, acquiring data from an engine of a machine, such as a car, truck, aircraft, boat, etc. which has been exposed to a set of load sessions, such as driving/flying/moving from point A to point B, thereby being exposed to various loads depending on a number of parameters, such as e.g. driving conditions, weather conditions, driver characteristics, etc. Accordingly, the set of load input data may hence be provided from a plurality of load sessions, i.e., it is not restricted from being provided from only one load session. However, the set of load input data may also be provided by experience, i.e., that certain machines are more or less always exposed to a certain type of loads for a specific driving scenario.

Moreover, the expression “first” described above is not intended to limit the scope of the present disclosure. The “first set of load input data” and “first set of load sessions” are not limited to first in terms of consecutive order, but may, for example, be a set of load input data for e.g. a third load session of the structure. Accordingly, the term “first” is merely used to more easily describe the method steps of the disclosure, which will be clearer below when describing various embodiments.

An advantage of the presently disclosed subject matter is, at least, that simplified calculation models may be provided for various components of a structure, which simplified calculation models are able to provide, e.g., stress, strain, and/or temperature results for components exposed to various sets of loads at an increased speed in comparison to prior art solutions using, e.g., FE-models. As the simplified calculation model is generated by means of using input data and corresponding results from a numerical calculation model, which is assumed to calculate and provide correct results for the component, a substantially robust and confident model may be provided.

The simplified calculation model may be in particular advantageous to use for complex components having a number of critical positions which are of interest in acquiring stress-, strain- and/or temperature results, since such a component in, e.g., an FE-analysis may require a large number of nodes and elements in order to achieve correct and reliable results, resulting in a very time consuming analysis. By generating a simplified calculation model in accordance with the present disclosure, the FE-analyses may only have to be executed the specific number of times it takes until the simplified calculation model is considered reliable and sufficiently validated. Thereafter, new set of load input data may be provided to the simplified calculation model for calculating stresses, strains and/or temperatures for the component, thereby reducing the time consumption for doing mechanical and thermal analysis.

Moreover, the method may further comprise the steps of: receiving a second set of load input data resulting from a second set of load sessions during operation; calculating at least one of stresses, strains and temperatures for the critical area of the component by means of the numerical calculation model; predicting life consumption of the component based on the at least one of the numerically calculated stresses, strains and temperatures; calculating at least one of stresses, strains and temperatures for the critical area of the component by means of the simplified calculation model; predicting life consumption of the component based on the at least one of stresses, strains and temperatures calculated by means of the simplified calculation model; and verifying that the simplified calculation model is correct if a difference between the numerically calculated predicted life consumption and the predicted life consumption predicted by means of the simplified calculation model is within a predetermined life consumption limit.

Hereby, a verification of the simplified calculation model may be provided so that the predicted life consumption calculated by the simplified calculation model is within a predetermined limit in comparison to the predicted life consumption calculated by the numerical calculation model. Depending on the desired accuracy of the results, the method may have to be executed for a plurality of times until the difference is within an acceptable limit range. Accordingly, the predetermined life consumption limit can be different for different applications. For example, if verification is made for a component in a truck, an accepted difference in predicted life consumption may be higher compared to a component in, e.g., an aircraft.

If the predicted life consumptions differ more than the acceptable predefined limit range, the parameters of the simplified calculation model may be adjusted by re-calculation and iteration of the parameters and thereafter compare predicted life consumptions for the two models again. Moreover, when the simplified calculation model is considered correct and subsequent analysis are performed for that model, a random validation of the model may be executed on a more or less regular basis in order to further validate the correctness of the model, which will be further described below.

Moreover, the term “second” should not be construed as limiting the scope of the present disclosure, for the same reasons as described above in relation to the wording “first”. Also, the second set of load input data may also not necessarily have to be a subsequent set of load input data following the first set of load input data; it should hence rather be interpreted as a load input data which is different from the first load input data.

According to an example embodiment of the present disclosure, the step of predicting life consumption of the component based on the at least one of stresses, strains and temperatures calculated by means of the simplified calculation model may be preceded by the steps of: comparing the numerically calculated stresses and/or strains with the stresses and/or strains calculated by the simplified calculation model; and predicting life consumption of the component based on the at least one of stresses, strains and temperatures calculated by the simplified calculation model if a difference in stresses and/or strains is within a predetermined stress and/or strain limit.

Hereby, the stresses and/or strains calculated by means of the numerical calculation model and the simplified calculation model may be compared to each other to provide an initial indication that the simplified calculation model is correct or not. The stress and/or strain limit may hence provide a measure of the likelihood that the simplified calculation model will provide reliable results in terms of life consumption. An advantage is that a further parameter is provided for verification of the simplified calculation model. Furthermore, the predetermined stress and/or strain limit may vary depending on the desired accuracy of the results as described above in relation to the predetermined life consumption limit.

Furthermore, the step of predicting life consumption of the component based on the at least one of stresses, strains and temperatures calculated by the simplified calculation model may be preceded by the steps of: comparing the numerically calculated temperatures with the temperatures calculated by the simplified calculation model; and predicting life consumption of the component based on the at least one of stresses, strains and temperatures calculated by means of the simplified calculation model if a difference in temperatures is within a predetermined temperature limit.

An advantage is that a still further comparison of the numerical model and the simplified calculation model may be provided for indication of the correctness of the simplified calculation model. The comparison of temperatures may be provided in combination with the comparison of stresses and/or strains, or the different comparisons may be executed independently of each other. Similar to the above description, the predetermined temperature limit may vary depending on the desired accuracy of the simplified calculation model.

Still further, the simplified calculation model may be generated by means of iteratively calculating the parameters of the linear difference equations until the verification that the simplified calculation model is within the predetermined life consumption limit.

According to an example embodiment of the present disclosure, the linear difference equations may comprise the equation:

yᵢ(t)+αᵢ_{_{—}}1xyᵢ(t−1)+ . . . +αᵢ_{_{—}}nαxyᵢ(t−na)=bᵢ_{_{—}}1xuᵢ(t−nk)+ . . . +bᵢ_{_{—}}nbxuᵢ(t−nk−nb+1)

wherein ui(t) are time-dependent inputs resulting from the load sessions during operation, yi(t) are time-dependent stresses, strains or temperatures, na and nb are the number of ai- and bi-parameters, respectively, and nk are the number of sample times before the current time t.

The equation described may hence provide a relation between the inputs, i.e. the loads, and the outputs, i.e. at least one of stresses, strains and temperatures, by means of the parameters.

Moreover, the linear difference equations may further comprise equations relating the stresses, strains and temperatures with the predicted life consumption.

Hereby, when the parameters of the simplified calculation model have been calculated, the stresses, strains and temperatures, i.e., the outputs from the above equation, are related to the predicted life consumption. This relation may be realized by means of a Wöhler diagram or the like which will be described further below.

According to an example embodiment, the simplified calculation model may be a linear ARX model having a plurality of parameters, wherein said parameters are estimated by means of said load input data and at least one of said calculated stresses, strains, temperatures and life consumption.

A linear ARX model is well known and comprises a plurality of parameters which may be iteratively calculated such that the parametric model corresponds to the real physical 2D- or 3D model, wherein the parameters are calculated by using the above method steps for generating the parametric calculation model. Accordingly, the linear ARX model is a linear difference equation calculating the parameters based on given input and given output. However, the disclosure should not be limited to a simplified calculation model using linear ARX, other so called “black box” algorithms are also conceivable, which uses known input and output to generate parameters for achieving the simplified calculation model.

Moreover, the simplified calculation model may comprise a temperature calculating module and a stress/strain calculating module. Hereby, separate modules are provided for calculating temperatures and stresses/strains of the component. Accordingly, when controlling the simplified calculation model, generation of parameters can be made separately for the temperature module and stress/strain module, thereby having a less number of parameters for each module compared to a single module calculating both temperatures and stresses/strains.

Still further, the calculated stresses, strains and temperatures may be time-dependent components. By calculating stresses, strains and temperatures as a function of time, the load history of the components are being taken into account, thereby calculating loads corresponding to an actual scenario of the component during a load session, which load session hence comprises a plurality of time-dependent loads.

According to an example embodiment, the load sessions may be constituted by recorded loads from a flight mission of an aircraft.

Hereby, when an aircraft has been exposed to a flight mission, the engine of the aircraft is connected to a computer or the like which receives information relating to the specific flight and hence to the time dependent loads exerted to the engine during the flight mission. Accordingly, depending on different flight conditions during the specific mission such as, e.g., weather, pilot behavior, etc., loads affecting the engine due to these conditions are provided from the engine in order to be able to calculate predicted life consumption for components during that specific mission.

Furthermore, the numerical calculation model may be a mesh-based numerical model using finite element calculations. As described above, finite element calculations may provide substantially accurate and reliable stress, strain and temperature results for a component exposed to a load session. As also described above, using a denser mesh, i.e., more nodes and elements per area, an improved accuracy of the results may be provided. Accordingly, by using finite element calculations for generating, verifying and validating the simplified calculation model, the model is generated for substantially accurate stresses, strains and temperatures corresponding to the true behavior of the component.

Still further, the load input data may comprise at least one of thermal- and mechanical loads. These types of loads are typically affecting a component during, for example, a flying session of an aircraft given as an example above. The mechanical loads may comprise velocity loads, gravitational loads, inertia loads, pressure loads, etc. The thermal loads may on the other hand comprise temperature differences during the load session, heat flux, friction, heat transfers, etc. The loads may also, as described above, be provided as a function of time, i.e., the load history of the mechanical and thermal loads may be included in the load input data.

According to a second aspect of the present disclosure, there is provided a method for predicting life consumption of a component subjected to loads during operation, comprising the steps of: receiving a first set of load input data resulting from a first load session during operation; calculating at least one of stresses, strains and temperature for a critical area of the component based on the first set of load input data by means of a simplified calculation model comprising linear difference equations; and predicting life consumption of the component for the first load session based on the at least one of the calculated stresses, strains and temperatures.

Hereby, a relatively rapid prediction of the life consumption for the component may be provided for the first load session, for example, an aircraft flying from point A to point B. Instead of using the above described prior art solutions; the simplified calculation model provides stresses, strains and temperatures of the component during the load session in a less time consuming manner compared to, e.g., a finite element analysis model. Thereafter, a prediction of the life consumption for the load session may be provided. In more detail, a ratio of the consumption of the total life time of the component may be predicted.

Furthermore, the simplified calculation model may be generated according to the above described first aspect of the present disclosure.

Moreover, the method may further comprise the steps of: receiving a second set of load input data resulting from a second load session during operation; calculating at least one of stresses, strains and temperatures for the critical area of the component by means of the simplified calculation model; predicting life consumption of the component for the second load session based on the calculated stresses, strains and temperatures; and adding the predicted life consumption resulting from the second load session with the predicted life consumption resulting from the first load session for accumulation of life consumption of the component.

Hereby, when the component has been exposed to another load session, for example, a flight from point B to point C, the predicted life consumption of the component when exposed to the flight from point B to point C may be added to the predicted life consumption of the component when exposed to the flight from point A to point B. Accordingly, an accumulation of the predicted life consumption for the component can be provided in order to continuously determine a remaining life time of the specific component. The terms “first load session” and “second load session” should hence, as also described above, not limit the scope of the present disclosure to include only two load sessions. The method naturally calculates and adds predicted life consumption continuously for new load sessions, such as, e.g., new flights, until the component is in need of replacement. Thereafter, when the component has reached its total lifetime, it may be replaced by a new component and the steps of the method may be re-started.

Furthermore, the life consumption may be predicted by means of calculating principal stresses and/or strains exposed to the structure in combination with temperature loads. Calculation of principal stresses and/or strains can, by use of, e.g., a Wöhler diagram or the like, be used to determine the amount of life consumption being utilized by the component. When, as described above, adding predicted life consumption for a first load session with the predicted life consumption of a second load session, it may be essential to compare and add principal stresses having the same principal directions, i.e., the principal stress/strain component should hence be projected to correspond to the direction of corresponding principal stress/strain directions for other load sessions. Moreover, the method may be used for determining and detecting crack initiation of a component, since cracks are one important aspect when determining life consumption.

According to an embodiment, the method may be further preceded by the steps of: receiving a third set of load input data resulting from a third load session during operation; calculating at least one of stresses, strains and temperatures for the critical area of the component by means of the numerical calculation model and the simplified calculation model; predicting life consumption of the component for the third load session based on the at least one of stresses, strains and temperatures calculated by means of the numerical calculation model and the simplified calculation model; and validating that the simplified calculation model is correct if a difference between the numerically predicted life consumption and the predicted life consumption predicted by means of the simplified calculation model is within a predetermined life consumption limit.

An advantage is that a reliable model may be provided. The validation of the model may be executed on a regular basis.

Other aspects, features and advantages with this second aspect are largely analogous to those described above in relation to the first aspect of the present disclosure.

According to a third aspect of the present disclosure, there is provided a system for generating a simplified calculation model, wherein the system comprises: a load session module comprising load session information exposed to a machine during operation; a load input data module comprising load generating means for transformation of load session information to thermal and mechanical loads; a numerical calculation model comprising a temperature calculating module and a stress/strain calculating module; a simplified calculating module comprising a temperature calculating module and a stress/strain calculating module; and a life consumption prediction module comprising means for predicting life consumption based on at least one of stresses, strains and temperatures; wherein said system is configured to: receive a first set of load input data resulting from a first set of load sessions during operation; calculate at least one of stresses, strains and temperatures for a critical area of a component by means of the numerical calculation model; predict life consumption of the component based on the at least one of the numerically calculated stresses, strains and temperatures by the life consumption prediction module; and generate the simplified calculation model defining a relationship between load input data and predicted life consumption for the component by means of: assigning a plurality of linear difference equations for the simplified calculation model; and calculating parameters of the plurality of linear difference equations based on the relationship between the first set of load input data and at least one of the numerically calculated predicted life consumption.

According to a fourth aspect of the present disclosure there is provided a system for predicting life consumption of a component subjected to loads during operation, wherein the system comprises: a load session module comprising load session information exposed to a machine during operation; a load input data module comprising load generating means for transformation of load session information to thermal and mechanical loads; a simplified calculation model comprising a temperature calculating module and a stress/strain calculating module; and a life consumption prediction module comprising means for predicting life consumption based on at least one of stresses, strains and temperatures; wherein said system is configured to: receive a first set of load input data resulting from a first load session during operation; calculate at least one of stresses, strains and temperature for a critical area of a component based on the first load input data and by means of the simplified calculation model comprising linear difference equations; and predict life consumption of the component for the first load session based on the at least one of the calculated stresses, strains and temperatures.

According to an embodiment, the simplified calculation model is generated according to the above description in relation to the third aspect of the present disclosure.

According to a fifth aspect of the present disclosure there is provided a computer program product comprising a computer readable medium having stored thereon computer program means for causing a processing unit to generate a simplified calculation model of a component subjected to loads during operation, wherein the computer program product comprises: code for executing the method according to the above description in relation to the first aspect of the present disclosure.

According to a sixth aspect of the present disclosure there is provided a computer program product comprising a computer readable medium having stored thereon computer program means for causing a processing unit to predict life consumption of a component subjected to loads during operation, wherein the computer program product comprises: code for executing the method according to the above description in relation to the second aspect of the present disclosure.

The processing unit may preferably be provided in a server or similarly, and the computer readable medium may be one of a removable nonvolatile random access memory, a hard disk drive, a floppy disk, a CD-ROM, a DVD-ROM, a USB memory, an SD memory card, or a similar computer readable medium known in the art.

Features of the third, fourth, fifth and sixth aspects of the disclosure provide similar advantages as discussed above in relation to the previous first and second aspects of the disclosure.

Further features of, and advantages with, the present disclosure will become apparent when studying the appended claims and the following description. The skilled addressee realize that different features of the present disclosure may be combined to create embodiments other than those described in the following, without departing from the scope of the present disclosure and/or the below-claimed invention.

### BRIEF DESCRIPTION OF THE DRAWINGS

The above, as well as additional features and advantages, will be better understood through the following illustrative and non-limiting detailed description of an exemplary embodiment, wherein:

FIG. 1 is a flow chart schematically illustrating a method for generating a simplified calculation model according to an embodiment;

FIG. 2 is a block diagram schematically illustrating an embodiment of a flow chart for generating a simplified calculation model; and

FIG. 3 is a flow chart schematically illustrating a method for predicting life consumption of components.

### DETAILED DESCRIPTION OF EXEMPLARY EMBODIMENTS

The present invention will now be described more fully hereinafter with reference to the accompanying drawings, in which an exemplary embodiment is shown. The subject matter disclosed and claimed herein may, however, be embodied in many different forms and should not be construed as limited to the embodiment set forth herein; rather, this embodiment is provided for thoroughness and completeness. Like reference character refer to like elements throughout the description.

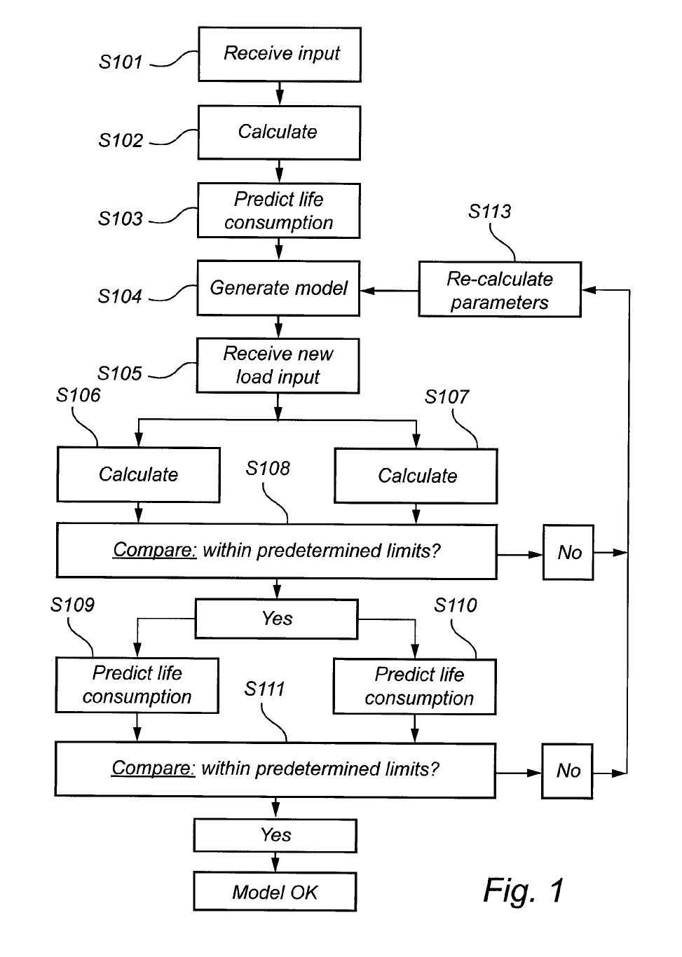

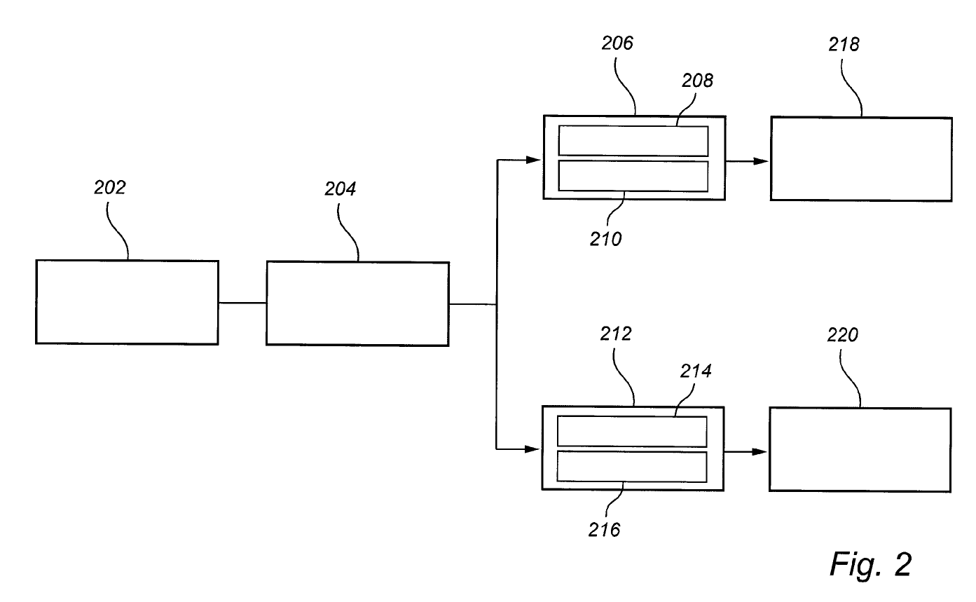

Reference is now made to the drawings and to FIGS. 1 and 2 in particular, that schematically illustrates a flow chart of an embodiment of a method for generating a simplified calculation model and a block diagram comprising the components for generating the simplified calculation model.

When generating the simplified calculation model 212 which is depicted in FIG. 2, load input is received S101 from a load session 202 in order to generate load input data 204. The load session 202 may, for example, be a flight session for an engine of an aircraft flying from point A to point B. Other types of load sessions are of course conceivable, such as a car or a truck driving from one point to another. The following description will, however, for simplicity of understanding only relate to an aircraft. The load session 202 can comprise a plurality of time-dependent parameters which has affected the aircraft during the flight from e.g. point A to point B. The parameters provided to the load input data 204 from the load session 202 may hence be different depending on, for example, weather conditions during the flight, pilot behavior, etc., and as the parameters are time-dependent, the loads affecting the engine will be continuously registered for the flight from point A to point B. Accordingly, the load session 202 provides time-dependent load data into the load input data 204 which generates, according to the loads affecting the engine during the flight, mechanical and thermal loads.

The mechanical and thermal loads generated at the load input data 204 are thereafter provided to a numerical calculation model 206. More specifically, the thermal loads are provided as input to a temperature module 210 of the numerical calculation model 206 and the mechanical loads are provided as input to a stress/strain module 208 of the numerical calculation module 206. The thermal 210 and stress/strain 208 module may, as an example, use a mesh-based calculation method, such as the Finite Element Method, FEM. Moreover, the thermal module 210 and the stress/strain module 208 thereafter calculates S102 time-dependent stresses, strains and temperatures exposed to a component of the aircraft engine during the load session. The calculated stresses, strains and temperatures of the component are thereafter provided to a life consumption prediction module 218 for predicting S103 the life consumption of the component during the load session 202. Accordingly, the life consumption prediction module 218 predicts how much of the components entire life that has been utilized during the load session. Therefore, a preferred aspect of the present disclosure is to take into account the internal load cycles which the component has been exposed to during the flight, and not only to check the stresses, strains and temperatures when the aircraft has landed.

Now, in order to generate S104 a simplified calculation model 212, the same load input data 204 provided to the numerical calculation model 206 is provided into the simplified calculation model 212. Also, the predicted life consumption generated in the life consumption prediction module 218 is provided to the simplified calculation module 212. Hereby, time-dependent inputs and time-dependent outputs are provided to the simplified calculation module 212 which enables calculation of the parameters of the simplified calculation model 212 by means of linear difference equations relating the time-dependent inputs to the time dependent outputs. As an example, the time-dependent inputs and the time-dependent outputs may be related according to the linear difference equation:

yᵢ(t)+αᵢ_{_{—}}1xyᵢ(t−1)+ . . . +αᵢ_{_{—}}nαxyᵢ(t−na)=bᵢ_{_{—}}1xuᵢ(t−nk)+ . . . +bᵢ_{_{—}}nbxuᵢ(t−nk−nb+1)
where:
uᵢ(t) are the time-dependent inputs resulting from the load sessions during operation,
yᵢ(t) are the time-dependent outputs, i.e. time-dependent stresses, strains or temperatures,
na and nb are the number of aᵢ- and bᵢ-parameters, respectively,
nk are the number of sample time before the current time t.

Hereby, the various parameters, i.e., a and b, may be calculated to generate the simplified calculation model 212. Moreover, the linear difference equation further comprises equations relating the outputs, i.e. yᵢ(t) with the predicted life consumption. In more detail, the simplified calculation module 212 also comprises a stress/strain module 214 and a temperature module 216. Accordingly, the thermal load input is configured to generate parameters of the thermal module 216 and the mechanical load input is configured to generate parameters of the stress/strain module 214. Hence, the above equation example may thus be arranged for the stress/strain module 214 and the thermal module 216, respectively.

To verify that the simplified calculation model 212 is correct, i.e., that life consumption prediction made by the simplified calculation model corresponds to corresponding life consumption prediction provided by means of the numerical calculation model, new load input data is received S105 for a new load session 202, both to the numerical calculation model 206 as well as to the simplified calculation model 212. Thereafter, the numerical calculation model 206 calculates S106 stresses, strains and temperatures exposed to the component during the new load session. Moreover, the simplified calculation model 212 also calculates S107 corresponding stresses, strains and temperatures for the simplified calculation model. As an intermediate step of verifying that the simplified calculation model 212 is correct is to compare S108 if the results in terms of stresses, strains and/or temperatures are within predetermined stress/strain-limits as well as within predetermined temperature limits between the numerical calculation model 206 and the simplified calculation model 212. If a difference in stresses and strains between the models is above the predetermined stress/strain limit and if a difference in temperatures between the two models is above the predetermined temperature limit, the parameters of the simplified calculation model 206 are re-calculated S112 by iteratively updating the parameters. The re-calculation S112 may be executed by providing a new load session 202 for receiving S101 a new load input and execute the method steps S101-S104 as described above. The re-calculation S112 may also be executed by iteratively modifying the parameters of the simplified calculation model 212 using the previously load input data and corresponding life consumption prediction made by the numerical calculation model 206 and to update the parameters. It should, however, be realized that the present disclosure is not limited to utilizing the step of comparing S108 stresses, strains and temperatures. In such a case the numerical calculation model 206 and the simplified calculation model 212 calculates S106, S107 stresses, strains and temperatures and provide the results to the life consumption prediction module 218, 220, whereby a comparison of the predicted life consumptions is made, which will be further described below.

Moreover, if the stresses, strains and temperatures are within the predetermined limits, the results from the numerical calculation model 206 as well as from the simplified calculation model 212 are each provided to their corresponding life consumption prediction modules 218, 220, respectively, in order to predict S109, S110 corresponding life prediction of the numerical calculation model 206 as well as the simplified calculation model 212. The simplified calculation model 212 is thereafter verified S111 by comparing the predicted life consumption generated by the simplified calculation model 212 with the predicted life consumption generated by the numerical calculation model 206. If a difference in predicted life consumption between the two models is within a predetermined life consumption limit, i.e., within a certain percentage individually determined by the importance of correctness of the results, the simplified calculation model 212 is considered to be verified and correct. If, however, the difference is above the predetermined limit, the parameters of the simplified calculation model 212 are iteratively re-calculated S112 as described above.

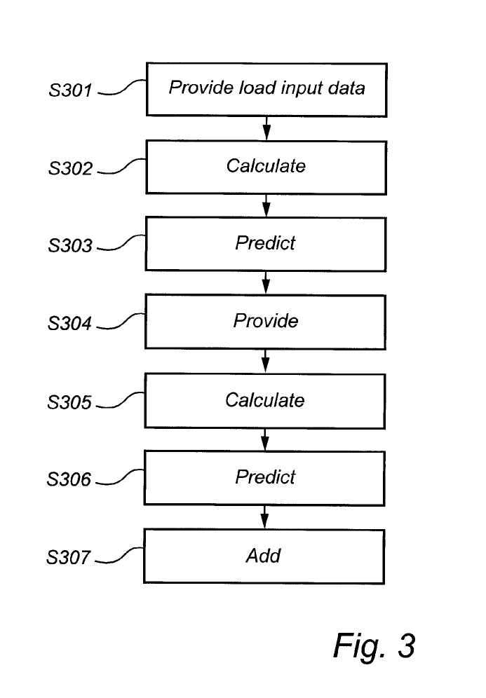

Now, when a simplified calculation model 212 is generated as described above, attention is drawn to FIG. 3 in combination with parts of FIG. 2, wherein FIG. 3 illustrates a flow chart of the method for predicting life consumption of components. It should be noted, that the simplified calculation model 212 generated as described above is only valid for one critical point/area for one component of the aircraft engine. Accordingly, in order to evaluate a plurality of critical points/areas in the aircraft engine, a plurality of simplified calculation models 212 have to be generated.

When the aircraft has made a new, first load session, data is provided from the aircraft engine such that the load input data module 204 can provide S301 load input data in terms of time-dependent mechanical loads and thermal loads, as described above, to the corresponding stress/strain module 214 and the thermal module 216 of the simplified calculation model 212. The simplified calculation model 212 thereafter calculates S302 time-dependent stresses, strains and temperatures which has affected the critical point of the component during the flight received from the load session module 202. The time-dependent stresses, strains and temperatures are provided from the respective modules 214, 216 of the simplified calculation model 212 to the life consumption prediction module 220 for predicting S303 the life consumption occurred during the specific flight. The predicted life consumption of the component for the first flight is thereafter stored. The predicted life consumption may hence be a percentage number of the total life of the component, such as, e.g., that the first flight affected the life consumption of the component by 0.2% of its total life.

When the aircraft thereafter has been exposed to a new, second load session 202, i.e., after the aircraft has flown from, e.g., a position B to a position C, new data is, similar the above description, provided to the load input data module 204 for providing S304 load input data in terms of time-dependent mechanical loads and thermal loads to the corresponding stress/strain module 214 and the thermal module 216 of the simplified calculation model 212. The simplified calculation model 212 thereafter calculates S305 time-dependent stresses, strains and temperatures which has affected the component during the second flight received from the load session module 202. The time-dependent stresses, strains and temperatures are provided from the respective modules 214, 216 of the simplified calculation model 212 to the life consumption prediction module 220 for predicting S306 the life consumption occurred during the second load session. The predicted life consumption is, again, stored.

Furthermore, in order to determine an accumulated life consumption of the component after the second load session, the predicted S303 life consumption of the component for the second load session is added S307 to the predicted S306 and stored predicted life consumption of the critical point of the component for the first load session. Hereby, an accumulation of predicted life consumption for the critical point of the component is provided.

Moreover, the method steps S301-S307 is thereafter continuously executed for all of the critical points of the component until a predetermined acceptable life consumption limit of the component has been reach, whereby the component can, for example, be replaced or repaired. The determination of if the component is ok or not may vary depending on the specific application where it is being used. For some applications the component is replaced if an indication of crack initiation has occurred, while for other applications cracks may be allowed within specific criteria of crack propagation. Moreover, for some applications, such as for, e.g., aircrafts, the component is replaced even before a crack is initiated.

Furthermore, although the simplified calculation model has been verified in the method step S111 above, the method steps S101-S111 may be executed within predetermined intervals for the component to further increase validation and to confirm the correctness of the model.

Moreover, although the above description has described that the stress/strain modules 208, 214 calculates stresses and strains, the present disclosure is equally applicable only calculating one of stresses or strains, i.e. the disclosure should not be construed as limited to calculation of both stresses and strains. Moreover, the stress/strain module, or other subsequent module may, if the stresses/strains from the numerical calculation model are provided as multiple stress/strain components, calculate a principal stress/strain component for comparison to the corresponding stress/strain component provided by the simplified calculation model.

Thus, the above description of the example embodiment and the accompanying drawings are to be regarded as a non-limiting example of the disclosed and claimed invention and the scope of protection is intended to be solely defined by the appended claims.

1-27. (canceled)

28. A method, comprising:
receiving a first set of load input data resulting from a first set of load sessions during operation of a machine that includes a component;
calculating at least one of stresses, strains and temperatures for a critical area of said component using a numerical calculation model;
predicting life consumption of said component based on said at least one of the numerically calculated stresses, strains and temperatures; and
generating said simplified calculation model defining a relationship between load input data and predicted life consumption by:
assigning a plurality of linear difference equations for said simplified calculation model; and
calculating parameters of said plurality of linear difference equations based on said relationship between the first set of load input data and said numerically calculated predicted life consumption.

29. The method according to claim 28, further comprising:
receiving a second set of load input data resulting from a second set of load sessions during the operation of the machine;
calculating at least one of stresses, strains and temperatures for said critical area of said component using said numerical calculation model;
predicting life consumption of said component based on said at least one of the numerically calculated stresses, strains and temperatures;
calculating at least one of stresses, strains and temperatures for said critical area of said component using said simplified calculation model;
predicting life consumption of said component based on said at least one of stresses, strains and temperatures calculated using said simplified calculation model; and
verifying that said simplified calculation model is correct if a difference between said numerically calculated predicted life consumption and said predicted life consumption predicted using said simplified calculation model is within a predetermined life consumption limit.

30. The method according to claim 29, wherein the step of predicting life consumption of said component based on said at least one of stresses, strains and temperatures calculated using said simplified calculation model is preceded by the steps of:
comparing said numerically calculated stresses and/or strains with said stresses and/or strains calculated using said simplified calculation model; and
predicting life consumption of said component based on said at least one of stresses, strains and temperatures calculated using said simplified calculation model if a difference in stresses and/or strains is within a predetermined stress and/or strain limit.

31. The method according to claim 29, wherein the step of predicting life consumption of said component based on said at least one of stresses, strains and temperatures calculated using said simplified calculation model is preceded by the steps of:
comparing said numerically calculated temperatures with said temperatures calculated using said simplified calculation model; and
predicting life consumption of said component based on said at least one of stresses, strains and temperatures calculated using said simplified calculation model if a difference in temperatures is within a predetermined temperature limit.

32. The method according to claim 29, wherein said simplified calculation model is generated using iteratively calculating said parameters of said linear difference equations until said verification that said simplified calculation model is within said predetermined life consumption limit.

33. The method according to claim 28, wherein said linear difference equations comprise the equation:
yᵢ(t)+αᵢ_{_{—}}1xyᵢ(t−1)+ . . . +αᵢ_{_{—}}nαxyᵢ(t−na)=bᵢ_{_{—}}1xuᵢ(t−nk)+ . . . +bᵢ_{_{—}}nbxuᵢ(t−nk−nb+1)
wherein ui(t) are time-dependent inputs resulting from said load sessions during the operation of the machine, yi(t) are time-dependent stresses, strains or temperatures, na and nb are the number of ai- and bi-parameters, respectively, and nk are the number of sample times before the current time t.

34. The method according to claim 33, wherein said linear difference equations further comprise equations relating the stresses, strains and temperatures with the predicted life consumption.

35. The method according to claim 28, wherein said simplified calculation model comprises a temperature calculating module and a stress/strain calculating module.

36. The method according to claim 28, wherein said calculated stresses, strains and temperatures are time-dependent components.

37. The method according to claim 28, wherein said load sessions are constituted by recorded loads from a flight mission of an aircraft.

38. The method according to claim 28, wherein said numerical calculation model is a mesh-based numerical model using finite element calculations.

39. The method according to claim 28, wherein said load input data comprises at least one of thermal- and mechanical loads.

40. A method, comprising:
receiving a first set of load input data resulting from a first load session during operation of a machine that includes a component;
calculating at least one of stresses, strains and temperature for a critical area of said component based on said first set of load input data using a simplified calculation model comprising linear difference equations; and
predicting life consumption of said component for said first load session based on said at least one of the calculated stresses, strains and temperatures.

41. The method according to claim 40, wherein said simplified calculation model is generated by:
assigning a plurality of linear difference equations for said simplified calculation model; and
calculating parameters of said plurality of linear difference equations based on said relationship between the first set of load input data and said numerically calculated predicted life consumption;

42. The method according to claim 40, further comprising:
receiving a second set of load input data resulting from a second load session during operation;
calculating at least one of stresses, strains and temperatures for said critical area of said component using said simplified calculation model;
predicting life consumption of said component for said second load session based on said calculated stresses, strains and temperatures; and
adding said predicted life consumption resulting from said second load session with said predicted life consumption resulting from said first load session for accumulation of life consumption of said component.

43. The method according to any claim 41, preceded by the steps of:
receiving a third set of load input data resulting from a third load session during operation;
calculating at least one of stresses, strains and temperatures for said critical area of said component using said numerical calculation model and said simplified calculation model;
predicting life consumption of said component for said third load session based on said at least one of stresses, strains and temperatures calculated using said numerical calculation model and said simplified calculation model; and
validating that said simplified calculation model is correct if a difference between said numerically predicted life consumption and said predicted life consumption predicted using said simplified calculation model is within a predetermined life consumption limit.

44. The method according to claim 40, wherein said linear difference equations comprises the equation:
yᵢ(t)+αᵢ_{_{—}}1xyᵢ(t−1)+ . . . +αᵢ_{_{—}}nαxyᵢ(t−na)=bᵢ_{_{—}}1xuᵢ(t−nk)+ . . . +bᵢ_{_{—}}nbxuᵢ(t−nk−nb+1)
wherein ui(t) are time-dependent inputs resulting from said load sessions during operation, yi(t) are time-dependent stresses, strains or temperatures, na and nb are the number of ai- and bi-parameters, respectively, and nk are the number of sample times before the current time t.

45. The method according to claim 41 wherein said linear difference equations further comprises equations relating the stresses, strains and temperatures with the predicted life consumption.

46. The method according to claim 40, wherein said simplified calculation model comprises a temperature calculating module and a stress/strain calculating module.

47. The method according to claim 40, wherein said calculated stresses, strains and temperatures are time-dependent components.

48. The method according to claim 40, wherein said load session is constituted by recorded loads from a flight mission of an aircraft.

49. The method according to claim 40, wherein said load input data comprises at least one of thermal- and mechanical loads.

50. A system, comprising:
a load session module comprising load session information exposed to a machine during operation;
a load input data module comprising load generating instructions for transformation of load session information to thermal and mechanical loads;
a numerical calculation model comprising a temperature calculating module and a stress/strain calculating module;
a simplified calculating module comprising a temperature calculating module and a stress/strain calculating module; and
a life consumption prediction module comprising instructions for predicting life consumption based on at least one of stresses, strains and temperatures; wherein said system is configured to:
receive a first set of load input data resulting from a first set of load sessions during operation;
calculate at least one of stresses, strains and temperatures for a critical area of a component using said numerical calculation model;
predict life consumption of said component based on said at least one of the numerically calculated stresses, strains and temperatures using said life consumption prediction module; and
generate the simplified calculation model defining a relationship between load input data and predicted life consumption for said component by:
assigning a plurality of linear difference equations for said simplified calculation model; and
calculating parameters of said plurality of linear difference equations based on said relationship between the first set of load input data and at least one of said numerically calculated predicted life consumption.

51. A system, comprising:
a load session module comprising load session information exposed to a machine during operation;
a load input data module comprising load generating instructions for transformation of load session information to thermal and mechanical loads;
a simplified calculation model comprising a temperature calculating module and a stress/strain calculating module; and
a life consumption prediction module comprising instructions for predicting life consumption based on at least one of stresses, strains and temperatures; wherein said system is programmed to:
receive a first set of load input data resulting from a first load session during operation;
calculate at least one of stresses, strains and temperature for a critical area of a component based on said first load input data and using said simplified calculation model comprising linear difference equations; and
predict life consumption of said component for said first load session based on said at least one of the calculated stresses, strains and temperatures.

52. The system according to claim 51, wherein said simplified calculation model is generated by:
assigning a plurality of linear difference equations for said simplified calculation model; and
calculating parameters of said plurality of linear difference equations based on said relationship between the first set of load input data and at least one of said numerically calculated predicted life consumption.
